(19) United States
(12) Patent Application Publication
(10) Pub. No.: US 2023/0025504 A1
(43) Pub. Date: Jan. 26, 2023

(54) QUERYING DEVELOPMENT TOOLCHAIN WORK ITEMS IN BATCHES

(71) Applicant: Hewlett-Packard Development Company, L.P., Spring, TX (US)

(72) Inventor: Marcus Avery, Spring, TX (US)

(73) Assignee: Hewlett-Packard Development Company, L.P., Spring, TX (US)

(21) Appl. No.: 17/783,033

(22) PCT Filed: Dec. 20, 2019
(86) PCT No.: PCT/US2019/067939

§ 371 Date: Jun. 7, 2022

(51) Int. Cl. G06F 8/77

(52) U.S. Cl. CPC G06F 8/77

(57) ABSTRACT

Examples are described herein for querying a development toolchain in batches. In various examples, an initial query may be executed in relation to the development toolchain. Based on the execution, a batch of additional queries may be identified that are responsive to the initial query. Each additional query may define criteria for identifying work items of the development toolchain. In response to the identifying, the batch of additional queries may be executed automatically to return respective sets of responsive results.

### BACKGROUND

Software development “toolchains” may include a set of tools that are used to perform various activities involved with complex software development and/or maintenance. For example, the “DevOps” (software development and information technology operations) toolchain may include individual tools geared towards particular activities such as planning, creating, verifying, packaging, releasing, configuring, monitoring, and/or version control. Tool(s) of a software development toolchain may include, maintain, or otherwise be associated and/or interact with a repository of “work items,” such as a work items service that conforms to and/or enforces principles of “Agile” software development. Each work item may represent a task that can be assigned to and/or performed by personnel associated with software development and/or maintenance. Work items may be created updated, resolved, and/or closed in order to manage the software development and/or maintenance workflow.

### BRIEF DESCRIPTION OF THE DRAWINGS

Features of the present disclosure are illustrated by way of example and not limited in the following figure(s), in which like numerals indicate like elements.

FIG. 1 is a drawing of an example environment in which selected aspects of the present disclosure may be implemented.

FIG. 2 depicts an example graphical user interface (“GUI”) depicting how techniques described herein may be used with a task scheduler, in accordance with some examples.

FIG. 3 depicts another example GUI depicting how queries configured with selected aspects of the present disclosure may be organized/accessed, in accordance with some examples.

FIG. 4 depicts an example GUI depicting how techniques described herein can be used to update a work item, in accordance with some examples.

FIG. 5 depicts another example GUI depicting how techniques described herein can be used to update a work item, in accordance with some examples.

FIG. 6 depicts an example method of practicing selected aspects of the present disclosure.

FIG. 7 depicts an example computer architecture.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

Various tools of a software development toolchain may enable personnel such as project managers to build “queries” that, when executed, return responsive work items. The project manager may then take action on these work items, e.g., by manually editing them, assigning them to appropriate entities, composing/sending out emails to relevant personnel requesting action, creating offshoot work items, etc. However, with complex software code bases, large numbers of work items may accumulate, making searching for, and taking action upon, particular work items time consuming and tedious.

Examples are described herein for querying development toolchain work items in batches in order to streamline efforts of personnel such as a project manager of a software toolchain system. By querying work items in batches, it is possible for a project manager to take action on work items en masse, rather than individually. For example, batches of queries may be executed to identify responsive work items associated with the development toolchain. Based on a given responsive work item and/or the respective query of the batch that returned the given responsive work item, action may be taken automatically in association with the given responsive work item. Batches of queries can also be executed automatically, e.g., in accordance with a schedule dictated by a project manager. This may enable the project manager to automate various project management tasks that previously consumed undue amounts of their time.

Various actions may be performed automatically in association with work items of a development toolchain that are responsive to queries. In some examples, a state of a given work item may be changed and/or updated in response to being identified by a query. Suppose each query of a batch of queries returns a set of responsive work items related to bugs detected in an application release. For example, one query may return bug-related work item(s) created via one tool of the software development toolchain, another query may return bug-related work item(s) created via another tool of the software development toolchain, and so forth. In some examples, some of these responsive work items may be updated automatically to include missing data elements that are included in others of the responsive work items.

To illustrate, suppose a project manager has a policy that new bugs detected at any stage of a development toolchain should be labeled or tagged for “bug triage,” Personnel working under the project manager may not be aware of this policy, may forget, may be negligent in creating bug-related work items, etc. And in some cases, various tools of the development toolchain may not be equipped to add such a tag to work item(s). Consequently, some bug-related work item(s) may lack this tag. To find and fix bug-related work items lacking this tag, the project manager may create and/or collect a batch of queries that obtains, e.g., from multiple tools of the development toolchain at once, bug-related working items. Then, each of the bug-related work items may be checked to see whether it includes the “bug triage” tag, and if not, may be updated to include the tag.

To further illustrate, the project manager may require that work items tagged for “bug triage” be assigned to particular entities (e.g., individual software engineers, particular departments) before the “bug triage” tag is removed. Once that occurs, those bug-related work items may be transitioned, for example, into a new “in process” state. To ensure these triaged work items do not go stale, another batch of queries may be executed (on demand or automatically) to, for instance, gauge workflows of entities. In some examples, this additional batch of queries may be triggered by an initial query that seeks out other queries that return information about workloads (e.g., # of work items assigned). The initial query may also include logic (e.g., a command) that, for instance, generates and sends, to entities with relatively light workloads, emails seeking volunteers to address the bug-related work item(s). In other examples, entities with light workloads and applicable skillsets may be automatically assigned work item(s).

In some examples, an initial query may be executed to identify a batch of additional queries that are responsive to the initial query. In some examples, when the initial query is executed, a list of search terms may be obtained, e.g., from local memory, from a network resource, etc. These search terms may then be used during execution of the initial query to seek additional queries that match those search terms. This enables project managers to avoid editing the initial query itself (which may require some technical knowhow), Instead, a project manager may edit the list of search terms to include works or phrases (e.g., intra-company nomenclature) they are familiar with. In some examples, the batch of additional queries that are responsive to the initial query may be executed automatically to return respective sets of responsive results.

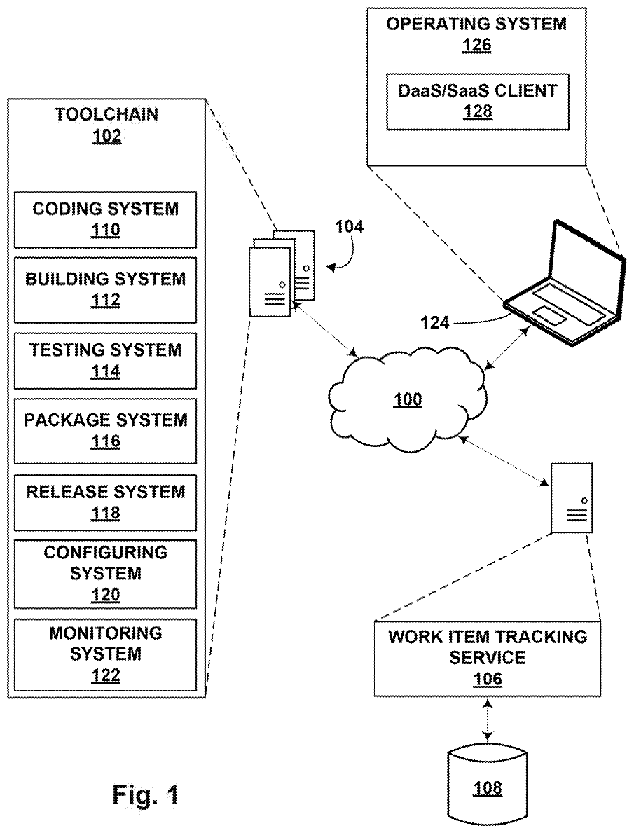

FIG. 1 is a schematic drawing of an example environment in which selected aspects of the present disclosure may be implemented. The components depicted in FIG. 1 may take various forms, such as a microprocessor that executes computer-readable instructions stored in memory, an application-specific integrated circuit (“ASIC”), a field-programmable gate array (“FPGA”), etc.

In FIG. 1, various systems of a development toolchain 102 are implemented on a computing system 104 that may include one computer or multiple computers in wired and/or wireless network communication with each other, e.g., via network(s) 100 such as a local area network (“LAN”), a wide area network (“WAN”), or any combination thereof. Also connected to network(s) 100 is a work item tracking service 106 and an example client device 124.

Development toolchain 102 may include multiple systems associated with corresponding phases of a software development toolchain. The systems 110-122 depicted in FIG. 1 are based on the DevOps toolchain paradigm. To wit, toolchain 102 includes a coding system 110, a building system 112, a testing system 114, a package system 116, a release system 118, a configuring system 120, and a monitoring system 122. However, this is not meant to be limiting. Techniques described herein are equally applicable to other variations of software development toolchains, e.g., such as those associated with Agile software development, variations of the DevOps toolchain (e.g., plan→create→verify→package→release→configure→monitor→version control) and so forth.

The various systems 110-122 of toolchain are depicted separately because in many instances, each system may be implemented by separate entities, under the same organizational umbrella or distinct from each other. In some instances, each system may be implemented at its own site, with its own set of computing devices and/or servers executing various components of the system. However, in other instances, various systems 110-122 may be combined with each other, add, or omitted, Moreover, although it is possible that separate personnel may operate and/or interact with each system, in other instance, various personnel may operate and/or interact with (i.e. “straddle”) multiple systems.

The following descriptions of each system are meant to provide illustrative context for the present disclosure, and should not be taken as limiting in any way. As mentioned previously, numerous variations are possible in a software development toolchain. More generally, techniques described herein may be more broadly applicable with any sort of system or business process in which work item repositories are employed to manage the day-to-day activities of personnel such as employees.

Coding system 110 may be operable by and/or interacted with personnel associated with the coding stage of toolchain 102 to develop and/or review source code. Coding system 110 may also facilitate other related functions, such as code merging, source code management tools, etc. Building system 112 may be operable by and/or interacted with by personnel associated with the build stage of software development, and may include functionality such as continuous integration for merging work from different developers to a shared repository, e.g., daily.

Testing system 114 may be operable by and/or interacted with personnel associated with the testing stage of toolchain 102 to debug software and/or to test the software using continuous testing tools, which introduce development environment-triggered tests, among other things. Package system 116 may be operable by and/or interacted with personnel associated with the packaging stage of toolchain 102 to perform functions such as binary repository management, application pre-deployment staging, etc.

Release system 118 may be operable by and/or interacted with personnel associated with the release stage of toolchain 102 to review and/or approve releases, automate releases, etc. Configuring system 120 may be operable by and/or interacted with personnel associated with the configuration stage of toolchain 102 to perform functions such as infrastructure configuration and management, among other things.

Monitoring system 122 may be operable by and/or interacted with personnel associated with monitoring software that has been released to perform functions such as applications performance monitoring, end-user experience monitoring, etc. In some cases, monitoring system 122 and/or other systems of toolchain 102 may be associated with a Device as a Service (“DaaS”) and/or Software as a Service (“SaaS”) paradigm. With DaaS and/or SaaS, end users subscribe to, or “lease,” hardware and/or software as a service that is provided continuously by an entity such as a computer and/or software company. DaaS, for instance, typically includes full device management and managed services.

In some cases, when a computer/software company sells computing devices (one example referenced at 124 in FIG. 1), the company may install DaaS/SaaS clients 128, e.g., as part of or underneath an operating system 126 of computing device 124. These DaaS/SaaS clients 128 may collect statistics and/or monitor performance (with the end user's permission), and may report these back to, for instance, monitoring service 122. Monitoring service 122 in turn may respond to issues with various remedial actions, such as assigning work items to personnel suitable for resolving the issues.

Work item tracking service 106 may operate on a computing system that is separate from systems 110-122, as shown in FIG. 1, or combined with one or more of those systems 110-122. As one example, work item tracking service 106 may be implemented as part of monitoring system 122. In some examples, various individual systems of 110-122 may be combined with other systems of 110-122, and/or some systems may be omitted.

Work item tracking service 106 may practice selected aspects of the present disclosure to facilitate querying of work items of development toolchain 102 in batches in order to streamline efforts of personnel such as a project manager of a software toolchain system. These work items may be stored in various databases, such as individual database(s) associated with systems 110-122, and/or as a separate database 108 associated with work item tracking service 106.

In various examples, work item tracking service 106 may take the form of or include an application that is operable, e.g., by a project manager, to interact with and/or manage work items associated with all or multiple systems 110-122 of development toolchain. The project manager may be able to generate and submit queries to various systems 110-122 of toolchain 102 to retrieve responsive results, take responsive actions, and so forth.

As noted previously, large scale software development can involve numerous personnel, source code files/repositories, business interests, end users, and perhaps most notably, work items. This makes it difficult for a project manager to manage personnel by managing (e.g., querying) individual work items. Accordingly, in various examples, work item tracking service 106 may facilitate querying of development toolchain 102 in batches.

For example, work item tracking service 106 may execute an initial query in relation to development toolchain 102. Rather than identifying individual work items, this initial query may specify identify a batch of additional queries that are responsive to the initial query. For instance, in some examples, the initial query may identify a list of search terms (e.g., a defined text file, database table, etc.) that should be consulted by work item tracking service 106. When such an initial query is executed, the batch of additional queries that are identified may include those that match those search terms, Each additional query may then define criteria for identifying work items of the development toolchain. In response to identifying the batch of additional queries that are responsive to the initial query, work item tracking service 106 may automatically execute the batch of additional queries to return respective sets of responsive results, e.g., work items that matched criteria specified in additional queries of the batch.

In some examples, work item tracking service 106 may automatically take action in association with work item(s) responsive to the additional queries. For example, work item tracking service 106 may, based on a given responsive result of a given set of responsive results and a respective additional query that returned the given set of responsive results, automatically change a state of a given work item of the development toolchain.

A work item's state may be changed in various ways. In some examples, work item tracking service 106 may add a missing data element to the given work item. As a non-limiting example, a project manager may mandate that when bugs are discovered, they be quickly triaged in order that appropriate personnel are identified and assigned the tasks (work items) of resolving the bugs. One initial query that the project manager may run (or may schedule to run automatically) may be designed to return a number of additional queries targeting work items, e.g., from multiple of systems 110-122, that have been created recently to track newly-discovery bugs. Work items created for recently-discovered bugs that are not appropriately triaged, e.g., with a “triage” tag or label, may be automatically labeled as such. Consequently, the project manager may run another query to quickly see all triaged bug-related work items, so that the project manager can easily assign those work items to suitable personnel.

Additionally, in some examples, work item tracking service 106 may assign the work item to a particular entity, e.g., based on qualifications, assignments of similar work items, etc. For example, one query of a batch of additional may identify triaged bug-related work items. Another additional query of the batch may seek personnel that satisfy various criteria that are suitable for resolving various bug-related issues. Yet another additional query of the batch may seek personnel with the most capacity to take on new work, e.g., those with workloads that satisfy (or fail to satisfy) some threshold. Based on responsive results of these queries, work item tracking service 106 may assign bug-related work items to particular personnel (or to departments, groups, etc.).

As described previously, toolchain 102 may include multiple systems 110-122, and these systems may have varying levels of compatibility with each other. To enable a project manager to manage work items across all systems 110-122, in some examples, work item tracking service 106 may normalize or harmonize work items between multiple systems. Suppose given work item returned by a query of a batch of queries conforms to a first programming tool of the toolchain 102, such as package system 116. Suppose further that a related work item (e.g., returned from another query of a batch seeking related work items) associated with release system 118 does not conform a format or other parameters of package system 116. In some examples, work item tracking system 116 may automatically alter one work item associated with a first programming tool of toolchain 102 to conform with a second programming tool of toolchain 102.

Another action that may be taken by work item tracking service 106 using work items that are responsive to a batch of queries is sending out electronic correspondence such as emails, text messages, instant messages, etc., to various entities based on the responsive work items. For example, a batch of queries may return a list of work items. Data associated with those work items may be formatted, e.g., by work item tracking service 106, into tables or other formats that are suitable for communication using, for instance, email. In some implementations, the queries may be designed to cause these emails to be sent to predefined email aliases, rather than individuals' emails, e.g., so that operations can continue without interruption even when specific employees depart.

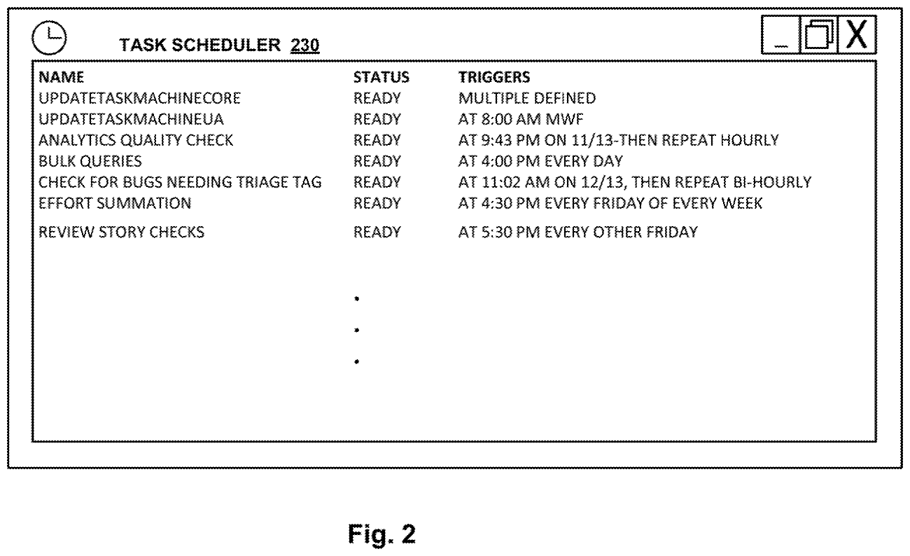

FIG. 2 depicts an example “Task Scheduler” graphical user interface (“GUI”) 230 that may be presented to a project manager or other similar personnel, e.g., by work item tracking service 106 or an underlying operating system. GUI 230 shows how batches of queries can be scheduled for execution in accordance with techniques described herein. Some of the tasks depicted by GUI 230, such as “updatetaskmachinecore,” may be unrelated to toolchain 102. However, others, such as “Bulk Queries,” may be executed to identify and execute batches of queries as described previously.

The initial query “Bulk Queries” in FIG. 2 may, in some examples, identify a list of search terms, e.g., from local memory, from a network resource, etc. These search terms may be used to identify additional queries that should be executed in response to execution of the “Bulk Queries” initial query. For example, Table 1 below shows an example list of search queries that might be consulted during execution of “Bulk Queries”:

TABLE 1
Testcasecheck
autobug
Bugcleanup
Testcasecoverage
Featureteststrategy
codecoverageforrepos

In some examples, when work item tracking service 106 executes the query entitled “Bulk Queries,” it may first access a text file or database that includes the search terms contained in Table 1 (or other similar or different search terms). Work item tracking service 106 may then search queries it has available to it, e.g., in database 108 or elsewhere in association with systems 110-122, that match these search terms (e.g., via metadata, query tokens, etc.). Then, work item tracking service 106 may execute the responsive additional queries to return responsive results, which as described above may cause work item tracking service to take various actions. In some cases, the search terms may in fact be commands that are executable at a command line prompt.

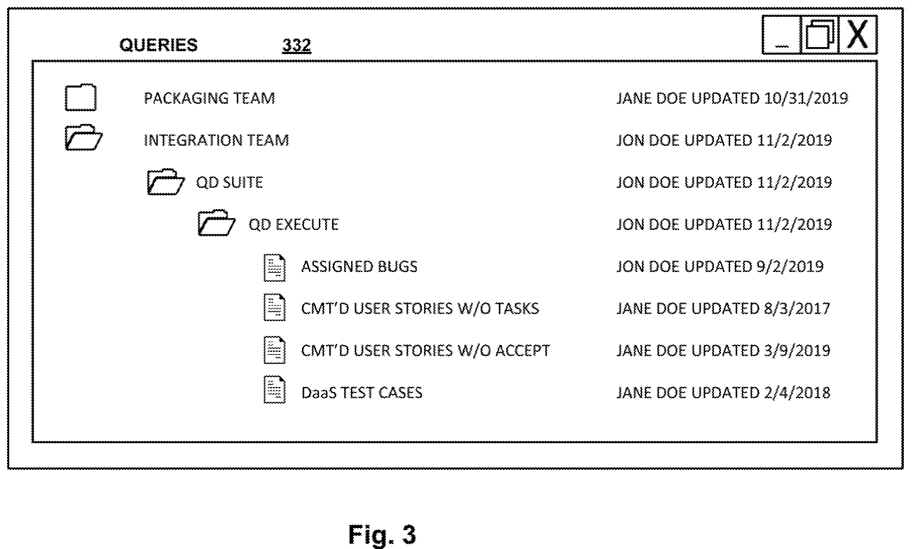

FIG. 3 depicts another GUI 332 showing how batches of queries might be organized. Here, a batch of queries associated with an “integration team” is entitled “QD Suite.” “QD” refers to a “query daemon,” which may be a process and/or user account that is used for purposes of executing queries described herein. The “QD Suite” of queries contains a subset of queries entitled “QD Execute.” QD Execute includes four different queries that are executed anytime the query daemon is activated (by a person or automatically by a task scheduler) to perform a “QD Execute” command. In some examples, these individual queries can be updated by users without requiring recompilation of work item tracking service 106.

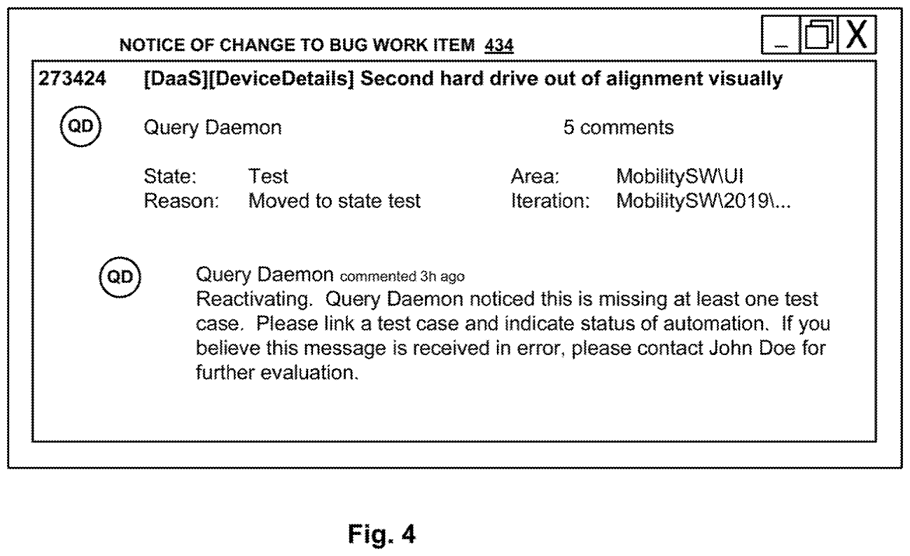

FIG. 4 depicts another GUI 434 demonstrating how a work item (273424) may be updated/altered in response to execution of batch queries in accordance with the present disclosure. GUI 434 may have been presented by work item tracking service 106, e.g., in response to a batch of queries seeking working bug-related work items that have been closed within some predetermined time interval, such as the last twenty-four hours.

GUI 434 shows how query daemon (“QD”) reactivated a particular work item, namely, 273424, and prevented a bug closure due to there not being at least one linked test case. A project manager and/or company policy may dictate that at least one test case be generated showing that a bug has been adequately addressed before a bug-related work item can be closed. The query daemon therefore requests that a relevant test case be linked to this work item, and that a status of automation be provided, before the work item (or at least its bug-related state) can be closed. As shown in FIG. 4, the query daemon, acting as a de facto user, may even update a conversation history associated with the work item in order to explain why it took the particular action.

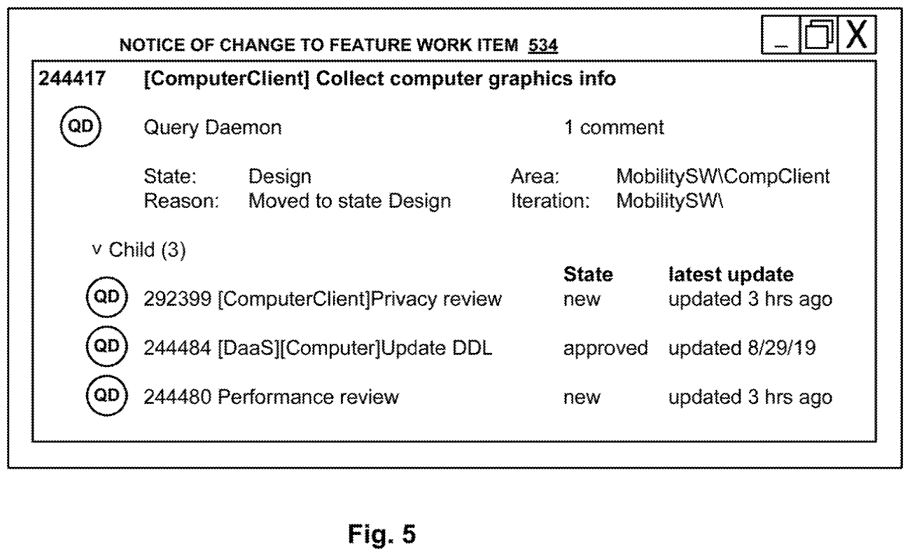

FIG. 5 depicts another GUI 536 demonstrating how a work item (244417) may be updated/altered in response to execution of batch queries in accordance with the present disclosure, Here, the work item 244417 (“Collect Computer Graphics info”) lacked some required child work items. Accordingly, this work item was responsive to a batch of queries that sought work items of this particular type that lacked appropriate (e.g., mandated) child items. As a responsive result, this work item was updated, e.g., by work item tracking service 106, to include appropriate child work items 292399 (“[ComputerClient]Privacy review”) and 244480 (“Performance Review”).

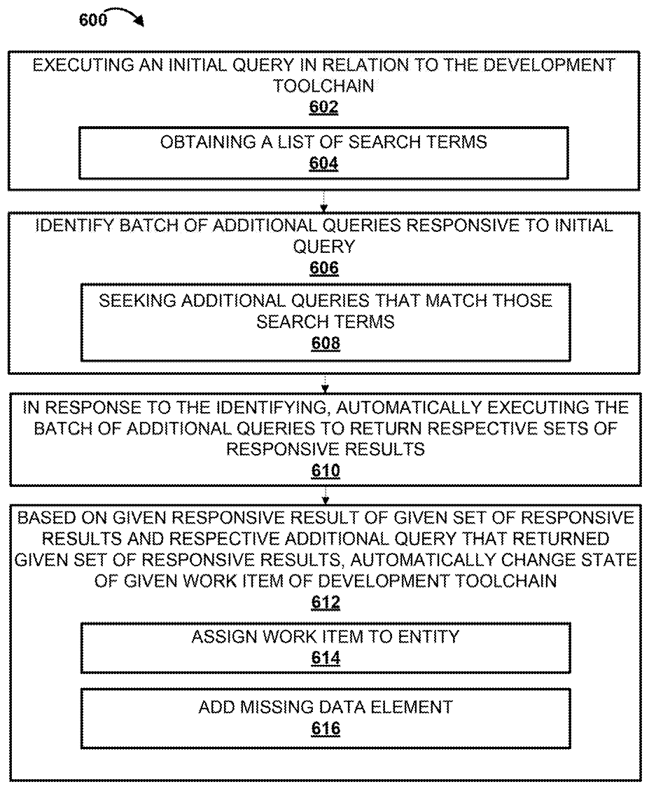

FIG. 6 depicts an example method 600 of practicing selected aspects of the present disclosure. For convenience, operations of method 600 will be described as being performed by a system configured with selected aspects of the present disclosure, such as work item tracking service 106. The operations in FIG. 6 are not meant to be limiting; various operations may be added, omitted, and/or reordered.

At block 602, the system may execute an initial query in relation to the development toolchain. As noted previously, in some examples, the initial query may identify or be associated with a list of search terms that should be used to match additional queries from various sources. One non-limiting example of search terms was provided above in Table 1. Accordingly, in some such examples, at block 604, the system may obtain that list of search terms.

Based on the executing of block 602, at block 606, the system may identify a batch of additional queries that are responsive to the initial query. Each additional query may define criteria for identifying work items of development toolchain 102. If a list of search terms was obtained at block 604, then at block 608, the system may seek additional queries that match those search terms. In other examples, the initial query may simply identify specific additional queries that should be executed.

In response to identifying the batch of additional queries at block 606, at block 610, the system may automatically (e.g., without human intervention) execute the batch of additional queries to return respective sets of responsive results. These respective sets of responsive results may include, for instance, sets of work items that are responsive to the sets of additional queries, a set of personnel that satisfy various criteria, or any other results that can be used to update, clear, close, create, or otherwise act upon work items.

At block 612, the system may, based on a given responsive search result of a given set of responsive results and a respective additional query that returned the given set, automatically change a state of a given work item of development toolchain 102. For example, the queries may seek work items associated with bugs discovered in the last 24 hours, and the queries (or the initial query) may also indicate that these work items should be updated to include the “triage” tag. In some examples, at block 614, the system may assign responsive work item(s) to suitable entities (which may also have been returned as responsive results). In some examples, at block 616, the system may add missing data elements to responsive work items.

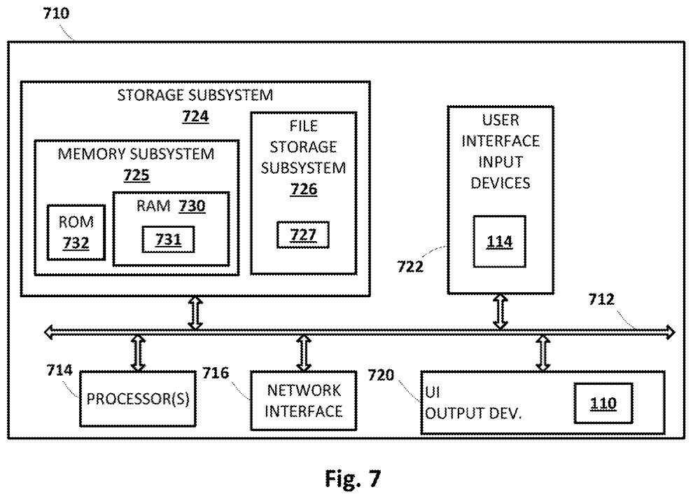

FIG. 7 is a block diagram of an example computer system 710. Computer system 710 may include a one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computer system 710. Network interface subsystem 716 provides an interface to outside networks and is coupled to corresponding interface devices in other computer systems.

User interface input devices 722 may include input devices such as a keyboard, pointing devices such as a mouse, trackball, a touch interaction surface, a scanner, a touchscreen incorporated into the display, audio input devices such as voice recognition systems, microphone(s), vision sensor(s), and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores machine-readable instructions and data constructs that provide the functionality of some or all of the modules described herein. These machine-readable instruction modules are executed by processor 714 alone or in combination with other processors. Memory 725 used in the storage subsystem 724 may include a number of memories.

For example, a main random access memory (“RAM”) 730 may be used during program execution to store, among other things, instructions 731 for querying a development toolchain in batches as described herein. Memory 725 used in the storage subsystem 724 may also include a read-only memory (“ROM”) 732 in which fixed instructions are stored.

A file storage subsystem 726 may provide persistent or non-volatile storage for program and data files, including instructions 727 for querying a development toolchain in batches as described herein, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 726, or in other machines accessible by the processor(s) 714.

Bus subsystem 712 provides a mechanism for letting the various components and subsystems of computer system 710 communicate with each other as intended. Although bus subsystem 712 is shown schematically as a single bus, other implementations of the bus subsystem may use multiple busses.

Computer system 710 may be of varying types including a workstation, server, computing cluster, blade server, server farm, or any other data processing system or computing device. Due to the ever-changing nature of computers and networks, the description of computer system 710 depicted in FIG. 7 is intended as a specific example for purposes of illustrating some implementations. Many other configurations of computer system 710 are possible having more or fewer components than the computer system depicted in FIG. 7.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A method for querying a development toolchain in batches, the method implemented using a processor and comprising:
executing an initial query in relation to the development toolchain;
based on the executing, identifying a batch of additional queries that are responsive to the initial query, wherein each additional query defines criteria for identifying work items of the development toolchain; and
in response to the identifying, automatically executing the batch of additional queries to return respective sets of responsive results.

2. The method of claim 1, comprising, based on a given responsive result of a given set of responsive results and the respective additional query that returned the given set of responsive results, automatically changing a state of a given work item of the development toolchain.

3. The method of claim 2, wherein automatically changing the state of the given work item includes adding a missing data element to the given work item.

4. The method of claim 2, wherein automatically changing the state of the given work item includes assigning the work item to a particular entity.

5. The method of claim 4, wherein the particular entity is identified based on assignments of similar work items.

6. The method of claim 2, wherein the given work item conforms to a first programming tool of the development toolchain, and automatically changing the state of the given work item includes altering the given work item to conform to a second programming tool of the development toolchain.

7. The method of claim 1, wherein executing the initial query includes obtaining a list of search terms, and identifying the batch of additional queries includes seeking additional queries that match those search terms.

8. The method of claim 1, wherein the initial query is executed automatically based on a schedule.

9. A non-transitory computer-readable medium comprising instructions that, in response to execution of the instructions by a processor, cause the processor to:
identify a batch of queries to be executed, wherein each query of the batch of queries seeks work items associated with a development toolchain;
execute the batch of queries to identify a plurality of responsive work items associated with the development toolchain; and
based on a given responsive work item of the plurality of responsive work items and the respective query that returned the given responsive work item, automatically take action in association with the given work item.

10. The non-transitory computer-readable medium of claim 9, wherein the action taken in association with the given work item comprises generation and transmission of an email that includes information about the given work item.

11. The non-transitory computer-readable medium of claim 9, wherein the action taken in association with the given work item comprises update of the given work item to include a missing attribute.

12. The non-transitory computer-readable medium of claim 9, wherein the action taken in association with the given work item comprises update of the given work item to conform with a criterion.

13. A system comprising one or more processors and memory storing instructions that, in response to execution of the instructions by the one or more processors, cause the one or more processors to:
in accordance with a schedule and without explicit human intervention:
search a query repository for a batch of responsive queries that match a list of search terms; and
execute the batch of responsive queries to return respective sets of responsive results, wherein each responsive result identifies a work item associated with a development toolchain.

14. The system of claim 13, further comprising instructions to automatically assign the work items associated with the respective sets of responsive results to entities associated with the development toolchain.

15. The system of claim 13, wherein the batch of responsive queries seek work item(s) from multiple different tools of the development toolchain, and the system further comprises instructions to harmonize a work item associated with one tool of the development toolchain with another work item associated with another tool of the development toolchain.
